(19) United States
(12) Patent Application Publication
(10) Pub. No.: US 2004/0120579 A1
(43) Pub. Date: Jun. 24, 2004

(54) Method and microscope for detecting images of an object

(75) Inventors: Franz Cemic, Weilmuenster (DE); Carola Blaesing-Bangert, Huettenberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Semiconductor GmbH, Wetzlar (DE)

(21) Appl. No.: 10/729,588

(22) Filed: Dec. 5, 2003

(30) Foreign Application Priority Data
Dec. 6, 2002 (DE) DE 102 57 323.9

(51) Int. Cl. G06K 9/62; G06K 9/00

(52) U.S. Cl. 382/209; 382/141

(57) ABSTRACT

A method for detecting images of an object includes: illuminating the object with a light source and imaging the object onto a detector using an imaging system so as to provide a detected image. A reference image is generated taking into account at least one property of the imaging system. The detected image is compared to the reference image. Upon a definable deviation between the detected image and the reference image, the reference image is varied so as to provide a varied reference image that at least largely corresponds to the detected image so as to enable conclusions to be drawn regarding the object.

This application claims priority to German patent application 102 57 323.9-52, which is hereby incorporated by reference herein.

The present invention concerns a method and a microscope for detecting images of an object, in particular for determining the localization of an object relative to a reference point, the object being illuminated with a light source and imaged with the aid of an imaging system onto a detector preferably embodied as a CCD camera, a detected image of the object being compared to a reference image.

### BACKGROUND

Methods and microscopes detecting an image of an object, in which a detected image of the object is compared to a reference image, have been known for some time. They are used in particular in coordinate measuring instruments that are employed for metrology of line widths or positions on substrates of the semiconductor industry. Reference is made purely by way of example to DE 198 19 492 A1 (and corresponding U.S. Pat. No. 6,323,953, which is hereby incorporated by reference herein), which discloses a measuring instrument for the mensuration of features on a transparent substrate. This measuring instrument provides highly accurate measurement of the coordinates of features on substrates, for example masks, wafers, flat screens, and vacuum-evaporated features, but in particular for transparent substrates. The coordinates are determined relative to a reference point, to an accuracy of a few nanometers. In this context, for example, an object is illuminated with light of a mercury vapor lamp and imaged onto a CCD camera using an imaging optical system.

As the packing density of the features used in the semiconductor industry constantly increases, feature widths and feature spacings are becoming smaller and smaller. The demands in terms of the specifications of these coordinate measuring instruments are becoming correspondingly stringent.

Feature widths and the spacings of features from one another have now already become smaller than the wavelength of the light used to detect the features. Optical measuring methods are nevertheless preferred for quality inspection in production, since their influence on the object is minimal and they allow a rapid measurement rate.

According to the Rayleigh criterion, the optical resolution limit is located at approximately half the wavelength of the light used to image the object, so that the detection of features whose spacings are smaller than the wavelength used to detect the features coincides with, or in some cases falls below, the optical resolution limit. The repeatability of object detections is, however, much better than the optical resolution capability of the imaging system. For example, the position of an edge of a feature can, in principle, be localized with a precision of <1 nm based on a threshold value criterion. At a technically achievable reproducibility of (at present) 3 nm, there is nevertheless a practical deviation on the order of up to 100 nm in the determination of feature widths of conductor paths. The reasons for this have to do principally with erroneous interpretation of measured values, in which diffraction effects in particular are insufficiently accounted for. Such refraction effects become more significant when the features to be measured are of the same order of magnitude as the wavelength of the light used for detection of the features, or when the features to be detected have adjacent features at a spacing less than one wavelength of the detection light.

Also known for the detection of feature position and for the determination of feature width, in addition to the method known from DE 198 19 492 A1 for the mensuration of features, is the method evident from DE 100 47 211. This is a “two-threshold-value method” with which the edge position of the detected features can be determined. These German references describe coordinate measuring instruments for measuring structures on substrates.

A gradient method for edge localization is known from the article “Optical Proximity Effects in Sub-Micron Photomask DC Metrology” by N. Doe and R. Eandi, 16th European Conference EMC on Mask Technology for Integrated Circuits and Microscopic Components, Munich 1999. The algorithm used therein for edge determination accounts approximately for diffraction effects and for the influence of a feature's adjacent features on its feature width determination.

In the method known from the aforementioned article, it is assumed that for each feature width and for each spacing value between two adjacent features, there exists in each case exactly one predefined error deviation. It is evident from this article, however, that the change in error deviation as a function of the spacing between two adjacent features depends in turn on the width of the features. The method known therefrom for feature width determination is accordingly only a very rough approximation for minimizing the errors that occur in the mensuration of “lines-and-spaces” structures using conventional algorithms (the gradient or two-threshold-value method). The term “lines-and-spaces structures” will refer hereinafter to structures that comprise adjacent linear features (lines) separated from one another by line-free regions (spaces).

In addition, the influence of adjacent edges on feature width determination is only very inadequately accounted for in the aforementioned article, since it deals with an approximation method in which the physical cause of the edge position shift is accounted for in generalized rather than in qualitatively exact fashion. The preconditions underlying this method are not met in all cases, however, since they are based inter alia on the assumption that the point response of the imaging system (point spread function, or PSF) is a straight-line function. Comatic aberrations of the imaging optical system, for example, or oblique illumination, break the symmetry of the assumptions made therein. For individual isolated lines, asymmetries in the PSF of the imaging optical system can indeed be taken into account via the optical transfer function (OTF) using the article's method. But as soon as the line to be measured has adjacent features, i.e., for example when a lines-and-spaces structure is present, the asymmetry that in general is always present is no longer taken into account. The result is that the feature width determination using the method known from the article is not independent of the environment of the feature being measured.

### SUMMARY OF THE INVENTION

It is therefore an object of the present invention to provide a method and a microscope by which an image of an object is detected, a detected image of the object being compared to a reference image, in such a way that errors in measured value interpretation are minimized.

The present invention provides a method for detecting images of an object, in particular for determining the localization of an object relative to a reference point, the object being illuminated with a light source and imaged with the aid of an imaging system onto a detector preferably embodied as a CCD camera, a detected image of the object being compared to a reference image. Information concerning the properties of the imaging system is taken into account upon generation of the reference image. In the context of a definable deviation of the compared images, the reference image is varied in such a way that it at least largely corresponds to the detected image, so that conclusions as to the object to be detected can be drawn.

What has been recognized according to the present invention is firstly that a minimization of errors in measured value interpretation can be achieved in particular when the properties of the imaging system are acquired in qualitatively exact fashion or at least to a very good approximation, and are taken into account in carrying out the method according to the present invention. For that purpose, according to the present invention, information concerning the properties of the imaging system enters into the generation of the reference image. This information could be generated, for example, computationally or by detection of a calibration object.

Comparison of the detected image to the reference image yields a small deviation in particular when the reference image is at least similar to the image of the object to be detected. Accordingly, a reference image that corresponds approximately to the image of the object to be detected could, for example, be generated. Knowledge of the object to be detected could, for example, be used for this purpose. In coordinate measuring instruments in particular, the object to be detected is in general known. For example, its shape and/or structure are known.

If the detected image of the object then deviates by a defined value from the reference image, provision is made according to the present invention for the reference image to be varied. The variation of the reference image could incorporate on the one hand the additional consideration of more extensive assumptions concerning the properties of the imaging system. It would be conceivable in this context, for example, for the PSF taken into account in the reference image, which is a straight line in the mathematical sense, to be supplemented with additional terms that do not have those symmetry properties. Comatic aberrations of the imaging optical system or oblique object illumination, for example, could thus be taken into account. On the other hand, a different imaging characteristic could be taken as the basis for generating the reference image. For example, generation of the reference image could be based on a coherent illumination instead of an incoherent illumination.

The method steps relating to variation of the reference image, and to comparison of the detected image of the object to the now-varied reference image, are repeated until the comparison of the images falls below a definable deviation. The detected image then at least approximately corresponds, in that regard, to the varied reference image. The result is that by way of this procedure it is possible to draw conclusions as to the detected object. This is understood to mean that as a result of knowledge of the properties of the imaging system, and by way of the comparison and variation steps according to the present invention, the features and properties of the detected object can be ascertained, even in terms of details that may lie below the resolution limit of the imaging system. The method according to the present invention thus does not increase the optical resolution of the imaging system as such; instead, based on the detected images of the object and a knowledge of the properties of the imaging system, a computational model is made of that object which, after a detection using the imaging system, would yield the image that was in fact detected.

When the deviation between the detected image of the object and the reference image falls below a definable value, it can accordingly be assumed that an error minimization in the measured value interpretation can be achieved even for features in the vicinity of and indeed, if applicable, below the resolution limit of the imaging system (in the context of the properties of the imaging system that are taken into account). It is thereby possible, in particularly advantageous fashion, to increase repeatability for multiple object detection, since measured value interpretation errors are decreased. The result is ultimately to increase the precision with which data are evaluated.

The manner in which the reference image is generated, and in which a variation of the reference image can be effected, will be discussed below.

Generation of the reference image will be described first. For this, provision is firstly made for generating an image characterizing the properties of the imaging system, or a function characterizing the properties of the imaging system. For generation of the image characterizing the properties of the imaging system, preferably a known object is detected using the imaging system. The known object could be a defined object feature, for example such as those used in the context of transparent substrates for the exposure of wafers. What is provided here as a defined object feature is preferably an individual conductor path feature that has one edge on each of its two sides. For generation of an image characterizing the properties of the imaging system, provision could furthermore be made to perform several detections of the same object at different angular positions in the object plane. For this purpose the object could thus be mounted in a rotary specimen stage and rotated through an angle of e.g., 10 degrees from one detection to the next, the rotation axis of the rotation being oriented parallel to the optical axis of the imaging system. Based on the images of the known object detected at different angular positions, it is possible to take into account and detect direction-dependent properties of the imaging system, e.g., asymmetries.

For implementation of the corresponding method steps on a computer, it may be advantageous if an analytical function characterizing the properties of the imaging system is extracted from the detected image of a known object. Fourier optics methods or numerical mathematical methods, in particular polynomial approximations, can be used for this. In particularly advantageous fashion, Struve functions are also used for representation of the analytical function, in which context symmetrical or asymmetrical Struve functions can be used. Asymmetrical Struve functions may be necessary especially when the images of a known object characterizing the properties of the imaging system that are detected at different angular positions in the object plane exhibit different imaging properties as a function of the object orientation. Asymmetrical Struve functions can be generated by linear combination of symmetrical Struve functions. The properties of Struve functions are summarized, for example, in the book by I. S. Gradshteyn and I. M. Ryzhik, “Table of Integrals, Series, and Products,” Academic Press 1980, pp. 982 and 983, which is hereby incorporated by reference herein.

As an alternative to generation of an image characterizing the properties of the imaging system, provision can be made for generation of a function characterizing the properties of the imaging system. Such a function is generated by calculation or simulation, preferably by means of an optics simulation program. In this context, the optical parameters of the imaging system, if they are known, are incorporated into the calculation or the simulation so that the function characterizing the properties of the imaging system describes the imaging process of the imaging system as accurately as possible. In particular, underlying assumptions as to the properties of the imaging system can also be introduced here, for example whether the object illumination is coherent or incoherent, or whether the vectorial nature of light waves or the scalar approximation was used for calculating the function characterizing the properties of the imaging system.

A function generated in this fashion and characterizing the properties of the imaging system is usable in general for all coordinate measuring instruments, but does not take into account the imaging properties of an individual unit that are actually present.

An artificial ideal image is furthermore generated by calculation or simulation, the artificial ideal image corresponding to the object to be detected. Digital image processing methods are preferably used for this purpose; interactive image generation using a corresponding computer program would likewise be conceivable. If the object to be detected comprises features of a transparent substrate for the exposure of wafers, manufacturer's image data that were used to generate the transparent features could also be employed.

The reference image is calculated from the function characterizing the imaging system and from the artificially generated image. If an image characterizing the imaging system was detected, provision is made for calculating the reference image from the image characterizing the imaging system and from the artificially generated image. The calculation is preferably a mathematical convolution operation that is to be performed in the local space. For two-dimensional images, a two-dimensional mathematical convolution is present. A corresponding application of the convolution theorem could be provided for in some circumstances, if the calculation operations necessary for the purpose using the convolution theorem can be performed more quickly than a convolution in the local space. The convolution theorem is described, for example, in J. W. Grodmann, Introduction to Fourier Optics, McGraw-Hill, N.Y., 1968, which is hereby incorporated by reference herein. In this, the Fourier transform of two images to be convoluted with one another is created, a multiplication of the Fourier-transformed images is performed, and an inverse Fourier transform of the product image is produced.

In an embodiment, the images or functions necessary for calculation of the reference image, and/or the reference image, are stored. The stored images or functions are preferably stored on a computer performing the image comparison and image variation, preferably in digital form. As a result, it is advantageously possible to generate the image characterizing the properties of the imaging system, or to calculate the function characterizing the properties of the imaging system, only once, so that the process step relevant thereto needs to be performed only once, so to speak as a “system calibration.”

The variation of the reference image is accomplished substantially by variation of the object of the reference image or the object features and/or the object shape of the reference image. Variation of the object features and/or the object shape could be accomplished, for example, by way of fit or variation algorithms; fuzzy-logic or artificial-intelligence methods could also be used here. Since the artificially generated image also enters into the reference image, variation of the reference image could also be accomplished by substantially performing the variation of the object features and/or of the object shape in the artificially generated image.

The comparison of a detected image to the reference image could be evaluated using a quality function, statistical and/or numerical evaluation steps preferably being provided for this purpose. Suitable normalization or scaling operations could also be provided here, specifically in order to adapt to one another the image intensity values of the images that are to be compared.

In an embodiment, the variation of the reference image and the comparison of the detected image to the reference image are repeated iteratively. The criterion provided for discontinuing the iteration is that the deviation of the images to be compared falls below a definable level.

The present invention also provides a microscope, preferably a coordinate measuring instrument, for detecting images of an object, in particular for determining the localization of an object relative to a reference point, the object being illuminated with a light source and imaged with the aid of an imaging system onto a detector preferably embodied as a CCD camera, a detected image of the object being comparable to a reference image. Information concerning the properties of the imaging system can be taken into account upon generation of the reference image. In the context of a definable deviation of the compared images, the reference image can be varied in such a way that it corresponds at least largely to the detected image, so that conclusions as to the object to be detected can be drawn.

The microscope according to the present invention serves in particular to carry out a method for detecting images according to the present invention. In an embodiment, the microscope is a coordinate measuring instrument for measuring structures or features on a substrate.

### BRIEF DESCRIPTION OF THE DRAWINGS

There are various ways of advantageously embodying and developing the teaching of the present invention. The reader is referred for that purpose on the one hand to the claims, and on the other hand to the explanation below of exemplary embodiments of the invention with reference to the drawings. In the drawings:

FIG. 1 is a schematic flow chart according to one exemplary embodiment of the method according to the present invention.

FIG. 2 schematically depicts individual method steps of the exemplary embodiment of FIG. 1.

FIG. 3 schematically depicts alternative method steps to FIG. 2.

FIG. 4 schematically depicts a coordinate measuring instrument according to the present invention.

FIG. 5 is a diagram of a detected and a calculated intensity profile of a line spread function (LSF) of the imaging system of a coordinate measuring instrument.

FIG. 6 is a diagram of detected and calculated intensity profiles of lines-and-spaces structures.

### DETAILED DESCRIPTION

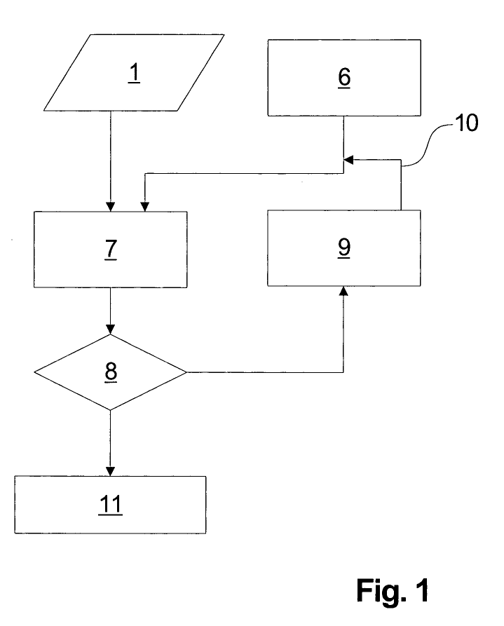

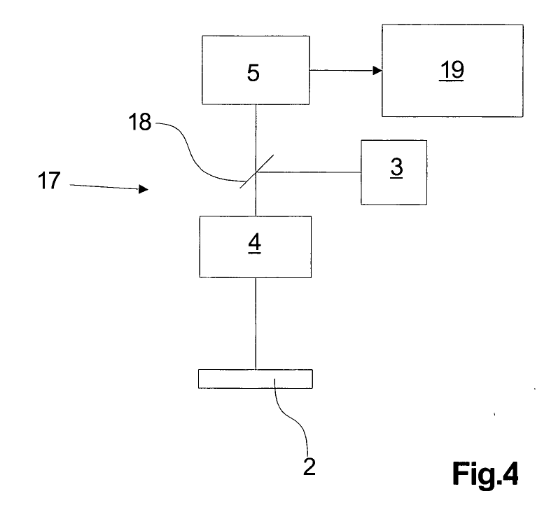

FIG. 1 schematically depicts a flow chart that shows an exemplary embodiment of a method for detecting images of an object 2. It is evident from FIG. 4 that object 2 is illuminated with a light source 3. Using imaging system 4, object 2 is imaged onto a detector 5 embodied as a CCD camera. This imaging operation is labeled in FIG. 1 with the reference character 1, the result of the object detection being an image of object 2. In method step 7, the detected image is compared to a reference image. The method step for generating the reference image is labeled with the reference character 6.

According to the present invention, information concerning the properties of imaging system 4 is taken into account upon generation of the reference image. If the images compared to one another at branching operation 8 exceed a definable deviation, then in method step 9 the reference image is varied in such a way that it corresponds at least largely to the detected image. For the next comparison, the original reference image is replaced by the reference image varied in accordance with method step 9, as indicated by the arrow labeled with reference character 10. If comparison operation 7 in combination with branching operation 8 yields a deviation of the compared images that falls below the definable value, according to the present invention conclusions can be drawn, in method step 11, as to object 2 that is to be detected. For example, provision could be made for outputting the detected image of object 2, together with an ideal image, on an image output unit. The ideal image would be the result of the method shown in FIG. 1, in which context conclusions can also be drawn here regarding details that lie below the resolution limit of imaging system 4.

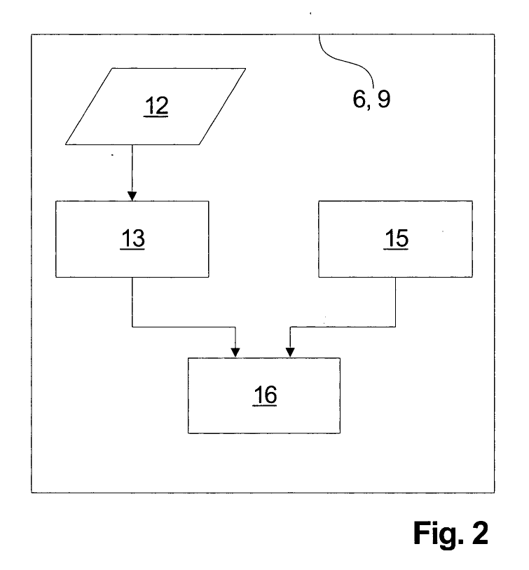

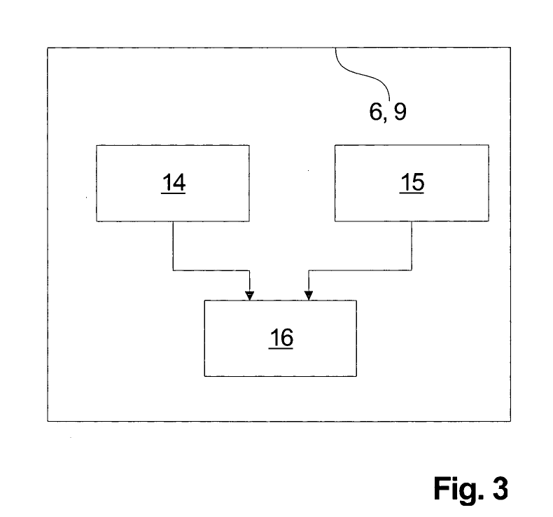

FIG. 2 shows the method steps that are provided in an embodiment of the method according to the present invention for generating the reference image in accordance with method step 6 or 9. A known object is thus detected with method step 12 using imaging system 4. Provision is made in method step 13 for extraction, from the detected image of the known object that is now available, of an analytical function characterizing the properties of the imaging system. In the alternative embodiment shown in FIG. 3 for generating the reference image in accordance with method step 6 or 9, method step 14 is used to generate, by simulation, a function characterizing the properties of the imaging system, an optics simulation program being used here. A function characterizing the properties of the imaging system is thus available here as well.

With method step 15 shown in FIGS. 2 and 3, an artificial ideal image corresponding to the object to be detected is generated by calculation. A prerequisite here is that the object to be detected be at least approximately known.

With method step 16 shown in FIGS. 2 and 3, the reference image is generated from the function characterizing the imaging system and from the artificially generated image. Method step 16 is a mathematical convolution operation. The result, ultimately, is that the imaging operation of the artificial ideal image—which should correspond to the image to be detected—is generated computationally.

Method step 9 for varying the reference image, shown in FIG. 1, is performed by variation of the object features and/or the object shape of the artificial ideal image that is generated in method step 15 shown in FIG. 2 or FIG. 3.

Method step 7 shown in FIG. 1 encompasses a comparison of the detected image to the reference image or to the varied reference image, the comparison being evaluated using a quality function. Statistical evaluation steps are provided, in particular, for this purpose.

As long as the evaluation of the comparison operation in accordance with method step 7 yields exceeds a definable deviation, method steps 9 and 7 (i.e., variation of the reference image and comparison of the detected image to the varied reference image) are repeated iteratively. The exemplary embodiment of the method according to the present invention could thus be referred to as a “reverse engineering” method: in the method steps shown in FIGS. 2 and 3, the artificial image corresponding to the object to be detected is “computationally imaged” and compared to the actually detected image until conformity exists between the compared images.

FIG. 4 shows a coordinate measuring instrument 17 according to the present invention for detecting images of an object. Coordinate measuring instrument 17 comprises a light source 3 with which object 2 is illuminated. Beam splitter 18 reflects approximately 50% of the light of light source 3, so that that light illuminates object 2 via imaging system 4. The light reflected from object 2 is imaged via imaging system 4 onto a detector 5 embodied as a CCD camera. The images of object 2 detected with detector 5 are transferred to a control and evaluation computer 19 on which the iterative comparison and variation method is implemented.

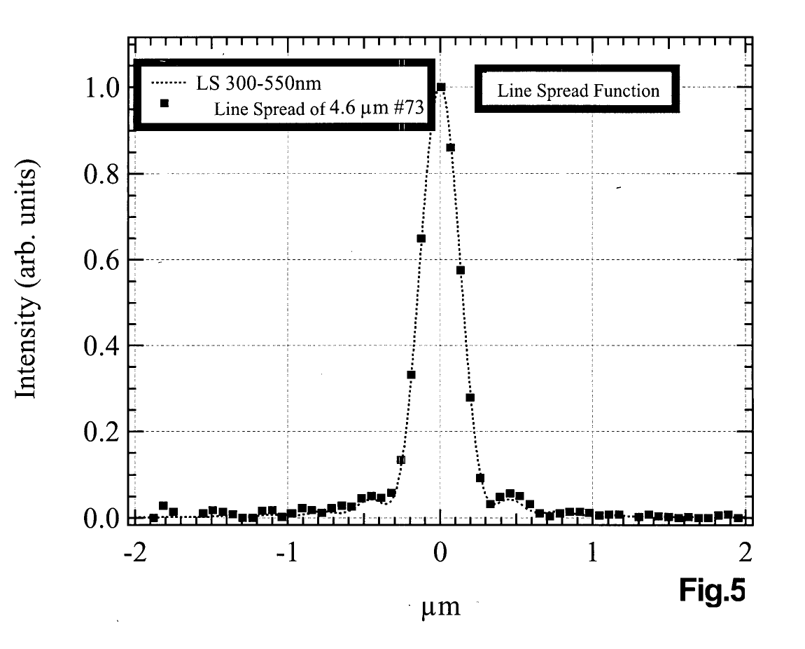

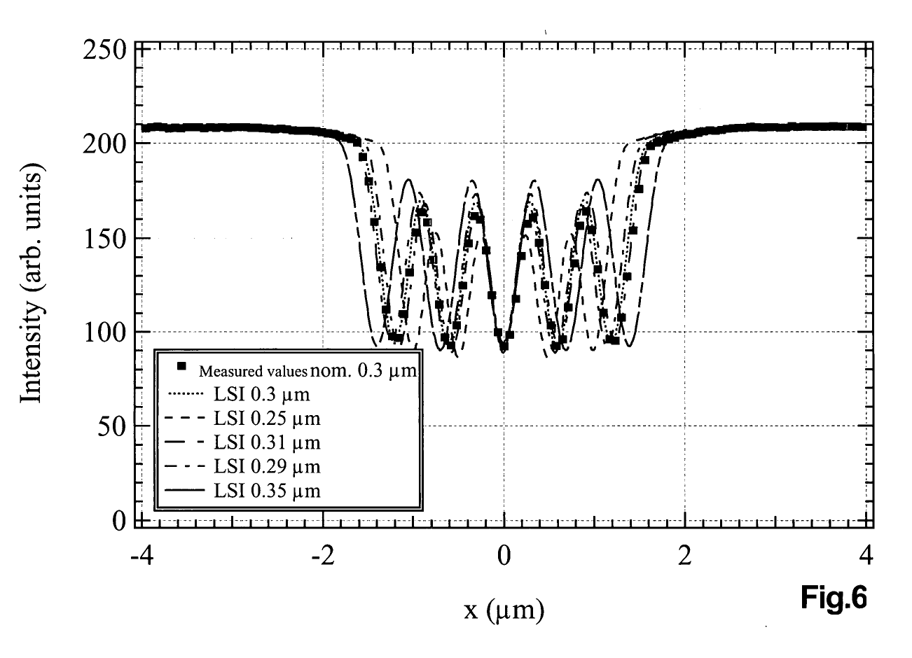

The result of the individual method steps is generally a two-dimensional image. The diagrams of FIGS. 5 and 6 each show intensity profiles of only one individual line of an image segment (region of interest) of the respective resulting image in which the respective feature is located.

FIG. 5 shows, in a diagram, the intensity profiles of a detected line spread function (LSF) (square measurement points) and the intensity profiles of a calculated LSF (dotted line). For the LSFs shown in FIG. 5, the measured and detected intensities are plotted as a function of the local coordinate in a direction perpendicular to the linear feature, in units of μm. The intensity profiles of the two LSFs shown in FIG. 5 are on the one hand the result of method step 12 of FIG. 2—a known object was detected using imaging system 4, the known object being a linear feature having a line width of 0.2 μm—and on the other hand the result of method step 14 of FIG. 3, the LSF having been calculated by incorporating the optical system data. An illumination wavelength region of 300 nm to 550 nm was taken as the basis for this calculation.

The intensity profiles shown in the diagram of FIG. 6 are on the one hand the result of method step 1 of FIG. 1, and on the other hand the result of method step 6 of FIG. 1. The intensity profile of a lines-and-spaces structure detected using coordinate measuring instrument 17 of FIG. 4 is marked with square symbols. The detected lines-and-spaces structure comprises five transparent lines of an opaque structure, the transparent lines having a width of 0.3 μm and a spacing of 0.3 μm from one another. The intensity profiles on the diagram in FIG. 6 likewise correspond to the change in intensity in a segment of the detected or calculated image along a line perpendicular to the lines-and-spaces structure. The detected intensity profile of FIG. 6., characterized by the square symbols, is the result of method step 1 of FIG. 1.

The (0.25 μm) intensity profile shown with a dashed line in the diagram of FIG. 6 corresponds to the result of method step 6 of FIG. 1. The intensity profiles shown with dotted, dot-dash, and solid lines in the diagram of FIG. 6 are the results of repeated application of method step 9 of FIG. 1. The basis for calculation in each case was an ideal lines-and-spaces structure having a line width and line spacing of 0.29 μm, 0.3 μm, 0.31 μm, and 0.35 μm, respectively.

The intensity profile plotted with a dashed line corresponds to a lines-and-spaces structure having a line width and line spacing of 0.25 μm in each case. It was generated in accordance with method steps 6, i.e., method steps 12, 13, 15, and 16 of FIG. 2. The basis used here was the measured LSF of FIG. 5, which is the result of method step 12 of FIG. 2. From this, in method step 13 of FIG. 2, an analytical function that describes the properties of imaging system 4 was extracted. The ideal artificial image was mathematically convoluted with this analytical function in accordance with method step 16 of FIG. 2. For calculation in accordance with method step 15 of FIG. 2, the basis for the ideal artificial image was a lines-and-spaces structure that has a line width and line spacing of 0.25 μm. The other calculated intensity profiles in the diagram of FIG. 6 are the results of varying the ideal artificial image of the lines-and-spaces structure (not shown) using different line widths and line spaces in each case: 0.29 μm, 0.3 μm, 0.31 μm, and 0.35 μm. These were also mathematically convoluted, in accordance with method step 16 of FIG. 2, with the image resulting from method step 13 of FIG. 2, and conveyed to method step 7 of FIG. 1, i.e., comparison of the detected image to the varied reference image.

It is further evident from FIG. 6 that the detected intensity profile (square symbols) conforms very closely to the calculated intensity profile of the 0.3-μm line width and line spacing. Upon comparison of the images corresponding to the two intensity profiles in method step 7 of FIG. 1, the definable deviation is accordingly not exceeded. The calculated image that is the basis for the 0.3-μm intensity profile is the result of method step 11 of FIG. 1.

In conclusion, be it noted very particularly that the exemplary embodiments discussed above serve merely to describe the teaching claimed, but do not limit it to the exemplary embodiments.

Parts List:

Detection of an image of (2)

Object

Light source

Imaging system

Detector

Generation of reference image

Comparison of detected image to reference image

Branching operation

Variation of reference image

Replacement of reference image with varied reference image

Draw conclusions as to detected image of object (2)

Detection of a known object

Extraction of an analytical function that describes the properties of (4)

Simulation of function characterizing the properties of (4)

Generation of an ideal artificial image corresponding to object (2) to be detected

Mathematical convolution of images resulting from method steps (13) and (15) or (14) and (15)

Coordinate measuring instrument

Beam splitter

Control and evaluation computer

What is claimed is:

1. A method for detecting images of an object, comprising:
illuminating the object with a light source;
imaging the object onto a detector using an imaging system so as to provide a detected image;
generating a reference image taking into account at least one property of the imaging system;
comparing the detected image to the reference image; and
varying, upon a definable deviation between the detected image and the reference image, the reference image so as to provide a varied reference image that at least largely corresponds to the detected image so as to enable a drawing of at least one conclusion regarding the object.

2. The method as recited in claim 1 wherein the method is usable for determining a localization of the object relative to a reference point.

3. The method as recited in claim 1 wherein the detector includes a CCD camera.

4. The method as recited in claim 1 wherein the generating a reference image is performed by generating an image characterizing the at least one property of the imaging system.

5. The method as recited in claim 4 wherein the generating the image characterizing the at least one property of the imaging system is performed by detecting a known object with the imaging system.

6. The method as recited in claim 5 wherein the detecting the known object is performed by detecting the known object at a plurality of angular positions in a plane of the object.

7. The method as defined in claim 5 further comprising extracting an analytical function from a detected image of the known object, the analytical function characterizing the at least one property of the imaging system.

8. The method as defined in claim 7 wherein the analytical function is represented by a symmetrical or asymmetrical Struve function.

9. The method as recited in claim 1 wherein the generating a reference image is performed by generating a function characterizing the at least one property of the imaging system.

10. The method as recited in claim 9 wherein the generating a function characterizing the at least one property of the imaging system is performed by calculation or simulation.

11. The method as recited in claim 10 wherein the simulation is performed using an optics simulation program.

12. The method as recited in claim 1 wherein the generating a reference image is performed by generating using calculation or simulation an artificial ideal image corresponding to the object.

13. The method as recited in claim 12 wherein the generating an artificial ideal image is performed using a digital image processing method.

14. The method as recited in claim 12 wherein the generating a reference image is performed by generating an image characterizing the at least one property of the imaging system and by calculation using the generated artificial ideal image and the generated image characterizing the at least one property of the imaging system.

15. The method as recited in claim 12 wherein the generating a reference image is performed by generating a function characterizing the at least one property of the imaging system and by calculation using the generated artificial ideal image and the generated function.

16. The method as recited in claim 14 wherein the calculation using the generated artificial ideal image and the generated image characterizing the at least one property of the imaging system includes a mathematical convolution operation.

17. The method as recited in claim 15 wherein the calculation using the generated artificial ideal image and the generated function includes a mathematical convolution operation.

18. The method as recited in claim 4 further comprising storing the generated image characterizing the at least one property of the imaging system.

19. The method as recited in claim 9 further comprising storing the generated function characterizing the at least one property of the imaging system.

20. The method as recited in claim 1 further comprising storing the generated reference image.

21. The method as recited in claim 20 wherein the comparing the detected image to the reference image is performed using a computer and wherein the storing is performed so as to store the generated reference image on the computer.

22. The method as recited in claim 1 wherein the varying the reference image is performed by varying at least one of a feature and a shape of the object.

23. The method as recited in claim 22 wherein the generating a reference image is performed by generating using calculation or simulation an artificial ideal image corresponding to the object and wherein the varying at least one of a feature and a shape of the object is performed by varying at least one of a feature and a shape of the generated artificial ideal image.

24. The method as recited in claim 1 wherein the comparing the detected image to the reference image is performed using a quality function.

25. The method as recited in claim 24 wherein the comparing the detected image to the reference image using a quality function is performed using at least one of statistical and numerical evaluation steps.

26. The method as recited in claim I further comprising:
comparing the detected image to the varied reference image; and
varying, upon a definable deviation between the detected image and the varied reference image, the varied reference image so as to provide a second varied reference image that at least largely corresponds to the detected image so as to enable a drawing of at least one conclusion regarding the object.

27. A microscope for detecting images of an object, comprising:
a light source for illuminating the object;
a detector;
an imaging system for imaging the object onto the detector so as to provide a detected image; and
a computer configured to:
generate a reference image taking into account at least one property of the imaging system;
compare the detected image to the reference image; and
vary, upon a definable deviation between the detected image and the reference image, the reference image so as to provide a varied reference image that at least largely corresponds to the detected image so as to enable a drawing of at least one conclusion regarding the object.

28. The microscope as recited in claim 27 wherein the microscope is a coordinate measuring instrument.

29. The microscope as recited in claim 27 wherein the microscope is capable of determining a localization of the object relative to a reference point.

30. The microscope as recited in claim 27 wherein the detector includes a CCD camera.
